(19) United States
(12) Patent Application Publication
(10) Pub. No.: US 2015/0350432 A1
(43) Pub. Date: Dec. 3, 2015

(54) MECHANISM FOR AVOIDANCE IN A GRAPH BASED CONTACT CENTER

(71) Applicant: Avaya Inc., Basking Ridge, NJ (US)

(72) Inventors: Robert C. Steiner, Broomfield, CO (US); Wen-Hua Ju, Monmouth Junction, NJ (US)

(73) Assignee: Avaya Inc., Basking Ridge, NJ (US)

(21) Appl. No.: 14/290,652

(22) Filed: May 29, 2014

(51) Int. Cl. H04M 3/51; G06Q 10/06

(52) U.S. Cl. CPC H04M 3/5175; G06Q 10/06311

(57) ABSTRACT

A mechanism for avoidance of one or more resources for work assignment based on nodes and relationships within an attribute tree of a graph based contact center is described along with various methods and mechanisms for administering the same. Avoidance methods are disclosed that allow an administrator to set up a graph database operable to automatically block work assignment to certain resources based on set rules and conditions. The graph database is additionally designed as a learning system that can adapt and respond to changing rules and conditions over time, including historically successful and unsuccessful interactions, attribute changes for customers and agents, and changes in desired results. Agent matching and customer satisfaction are improved with the avoidance of inappropriate or undesirable resources.

### FIELD OF THE DISCLOSURE

The present disclosure is generally directed toward communications and more specifically toward contact centers.

### BACKGROUND

Work assignment within a contact center is typically based on which resources or groups of resources are available and qualified and how the pool of resources may be matched in an efficient way to work items. Work items are placed into a queue or work item pool to be handled by the next best available resource.

### SUMMARY

Avaya's queueless contact center solution matches resources to work items based on a large number of attributes. One drawback, however, is that the current solution only assigns work based on the positive presence of certain attributes. There arise circumstances that warrant an avoidance of certain attributes. For instance, the contact center may want to avoid matching a particular agent to a work item if the agent has interacted with the customer previously and the interaction did not go well. It would be advantageous to the contact center to be able to avoid matching the agent to the customer a second time based on negative feedback obtained from the previous interaction.

It is with respect to the above issues and other problems that the embodiments presented herein were contemplated. In particular, embodiments of the present disclosure describe a system and method in which a work assignment engine can detect specific avoidance parameters or conditions, allowing the work assignment engine to actively make a choice not to assign a work item to a type of resource who is available for work and qualified to do the work based on attributes of the agent, the work item, and/or the customer attributes.

In a graph based contact center, nodes and relationships between nodes allow for significantly greater flexibility in work item to agent matching since all nodes and relationships reside in one central database. Within the extended flexibility, avoidance logic can provide a framework that a work assignment engine can use to consider attributes for inclusion and avoidance in the matching process. The avoidance logic may provide the ability to avoid a resource or a group of resources and may provide conditions and rules for when resources are to be avoided. The avoidance logic may also determine when a work item should not be routed to an available and qualified agent based on existing historical data.

Additionally, basic training sets for avoidance can be built for a graph based contact center system. The system can employ interactive intelligence to learn over time. A computational model similar to a neural net, capable of machine learning and pattern recognition, may allow the avoidance logic to build on and fine-tune the basic training sets, learning how to characterize and repeat successful avoidance. This allows the avoidance logic to automatically repeat the behavior in future transactions.

In a non-limiting example, a contact center might want a particular gender assigned to certain types of calls. Sarah may call into a nursing hotline. Sarah believes she is experiencing significant side effects from a drug for endometriosis. The contact center has determined over time that gender-specific topics are best handled by an agent of the same gender. The avoidance logic can be administered to automatically bypass Tim, even though Tim is available and qualified to take drug and side effect work items. The work item is sent to Madeline, who is also qualified and available and female. Madeline is able to talk to Sarah about the side effects of the medication and offers advice and reassurance regarding treatment and prognosis. Madeline resolves the issue to Sarah's satisfaction and great relief.

Using feedback including, but not limited to, customer survey, agent notes, and speech/emotion recognition solutions, the avoidance logic can fine-tune the matching from gender-specific topic to endometriosis and count the interaction as successfully handled by the female agent.

These and other advantages will be apparent from the disclosure.

In some embodiments, a method is provided that generally comprises:
receiving a work item in a contact center, the work item representing one or more customer contacts with the contact center;
identifying a first resource in the contact center as being a resource that is prohibited from being assigned to the work item even though the first resource is available and/or qualified to process the work item;
in response to identifying the first resource as a resource that is prohibited from being assigned to the work item, implementing avoidance logic that prohibits the work assignment engine from assigning the work item to the first resource;
determining, at the work assignment engine, that the first resource is available and qualified to process the work item;
after determining that the first resource is available and qualified to process the work item, implementing avoidance logic at the work assignment engine to prohibit the work assignment engine from assigning the work item to the first resource; and
preparing a report for a contact center administrator or supervisor that indicates the avoidance logic has been implemented for the first resource and the work item.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “element” and variations thereof, as used herein, refers to any person, component, work item, organization, device, engine, software, and hardware that is owned, managed, contacted, accessed, and serviced from or by a contact center which have one or more associated attributes. Examples of elements can include, but are not limited to, agents, customers, servers, applications, work items, tasks, groups, skills, communication devices, VDNs, IVRs, CMS, WFM, historical interactions, data, etc.

The phrase “attribute tree” as used herein refers to a set of attributes arranged as nodes that have relationships within a graph database. An attribute is a character, quality, or feature of an entity. Examples of attributes might include without limitation language preference, age, gender, name, region, product information, order information, historical information, and other demographics. Attributes are commonly considered for routing decisions by a work assignment engine to best meet goals and/or desired metrics for a contact center. The attribute tree can be used by a work assignment mechanism directly for matching, eliminating an attribute set and allowing the naturally defined relationships to provide simple proximity determination.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored. When the computer-readable media is configured as a database, it is to be understood that the database may be any type of database, such as relational, hierarchical, object-oriented, and/or the like.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram of a contact center graph database in accordance with embodiments of the present disclosure;

FIG. 3 is a block diagram of an attribute tree in a graph database in accordance with embodiments of the present disclosure;

FIG. 4 is a first flow diagram depicting a method for agent avoidance in accordance with embodiments of the present disclosure; and

FIG. 5 is a second flow diagram depicting a method for administration of an agent for agent avoidance in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

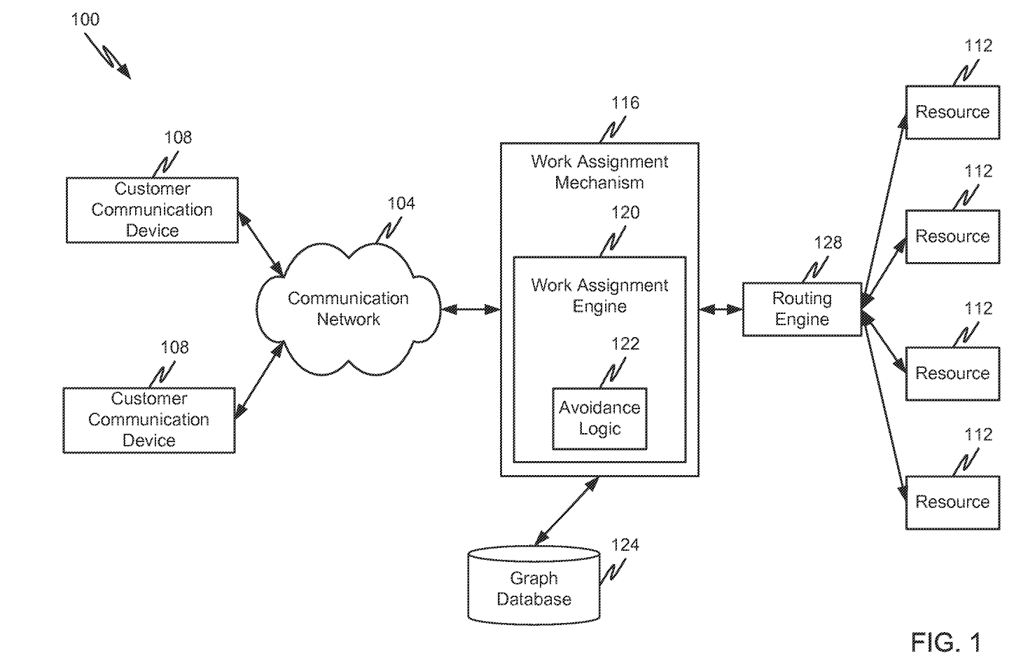

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a graph-based contact center, but such a configuration is not required. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating tasks based thereon are described in U.S. Patent Publication Nos. 2010/0235218, 2011/0125826, and 2011/0125793, to Erhart et al, filed Mar. 20, 1010, Feb. 17, 2010, and Feb. 17, 2010, respectively, the entire contents of each are hereby incorporated herein by reference in their entirety. The format of the work item may depend upon the capabilities of the communication device 108 and the format of the communication.

In some embodiments, work items and tasks are logical representations within a contact center of work to be performed in connection with servicing a communication received at the contact center (and more specifically the work assignment mechanism 116). With respect to the traditional type of work item, the communication associated with a work item may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 128 to connect the communication device 108 which initiated the communication with the assigned resource 112.

Although the routing engine 128 is depicted as separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 128. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. More specifically, the work assignment engine 120 can determine, based on an analysis, which of the plurality of processing resources 112 is eligible and/or qualified to receive a work item and further determine which of the plurality of processing resources 112 is best suited to handle the processing needs of the work item. In situations of work item surplus, the work assignment engine 120 can also make the opposite determination (i.e., determine optimal assignment of a work item to a resource).

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

The contact center can share a common data structure that describes state and extends easily to new and different concepts like goal management, process control, analysis, and context-rich work assignment using a graph database 124. The work assignment mechanism 116 may communicate with the graph database 124 for scalable, durable, and cost-effective modeling of the entire contact center. This model describes all aspects, categories, and elements of the contact center using nodes and relationships. The nodes can be anything of interest, including but not limited to an attribute (characteristic or feature), a resource, a work-item, a result, a measure, etc. This provides a specific set of information to effectively deliver telephony, data, and services from the communication network 104 to the customer communication devices 108.

In accordance with at least some embodiments of the present disclosure, avoidance logic 122 in the work assignment engine 120 within the work assignment mechanism 116 comprises algorithms that may actively prevent work assignment to qualified and available resources under certain conditions. More specifically, the avoidance logic 122 can actively detect specific avoidance parameters or conditions which may be administered by an administrator as hard blocks and/or conditional blocks. The avoidance logic 122 may additionally consider existing data, including historical interactions with and feedback from an individual and/or group. The avoidance logic 122 can also be administered by the administrator as a learning system that can create and enhance training sets, fine-tuning avoidance over time.

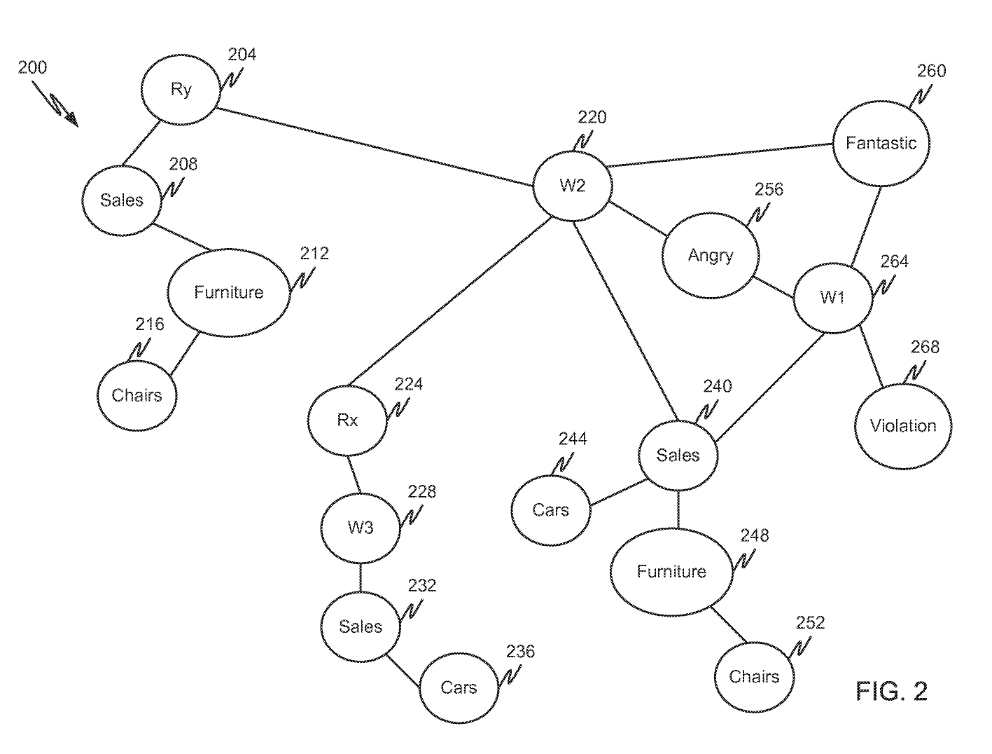

FIG. 2 depicts illustrative data structures 200 which may be incorporated in and used by a graph database 124 in accordance with embodiments of the present disclosure. The graph database 124 allows a contact center to utilize a common data structure that describes state information and extends easily to old and new concepts like attributes, goal management, process control, analysis, metrics, and context-rich work assignment.

The graph database 124 can describe everything within the contact center using nodes and relationships, and may describe the nodes/relationships in a contact center as attributes, work, outcomes, resources 112, etc. In most contact centers, work comes in and may be assessed by a work assignment mechanism 116. Work is typically then assigned by a routing engine 128 to a resource 112 in accordance with a work assignment decision made by the work assignment mechanism 116. In a non-limiting example, a resource x (Rx 224) can be described as capable of handling certain types of work (W3 228) like taking Service 232 calls for Cars 236.

In some embodiments, the graph database 124 categories can include attributes, which may represent a quality or feature of an element. Attributes are commonly considered for matching and routing decisions by a work assignment mechanism 116 to best meet goals and/or desired metrics for a contact center. The graph database 124 can use categories in an attribute tree directly for matching, allowing a naturally defined relationship to provide simple proximity determination.

The data structures 200 in the graph database 124 can grow manually and/or automatically, depending on the interaction with the communication system 100. For example, a resource (Ry 204) may be created by an administrator and be eligible to take work relating to a Shipping 208 category, a Furniture 212 sub-category, and a lower sub-category, Chairs 216. Ry 204 may receive a work item (W1 264) and bring the work item to resolution. The administrator may have created sub-categories Fantastic 260, Angry 256, and Violation 268 to describe the interaction between Ry 204 and W1 264. Details of the interaction may be preserved in an appropriate sub-category within the attribute tree. Ry 204 may receive an additional work item (W2 220), which now has relationship links with existing nodes and relationships may be created, like a connection to Fantastic 260. The graph database 124 may create a relationship between W2 220 and Rx 224 when another work item W3 228 is received and assigned if the Service 232 call for Cars 236 is from the same customer. Ry 204 may receive some additional training, allowing Ry 204 to take calls for a category of Sales 240 that may include the sub-categories of Cars 244 and Furniture 248, with an additional sub-category of Chairs 252. Additional nodes and relationships may be created as more work items come into the contact center and more categories are added.

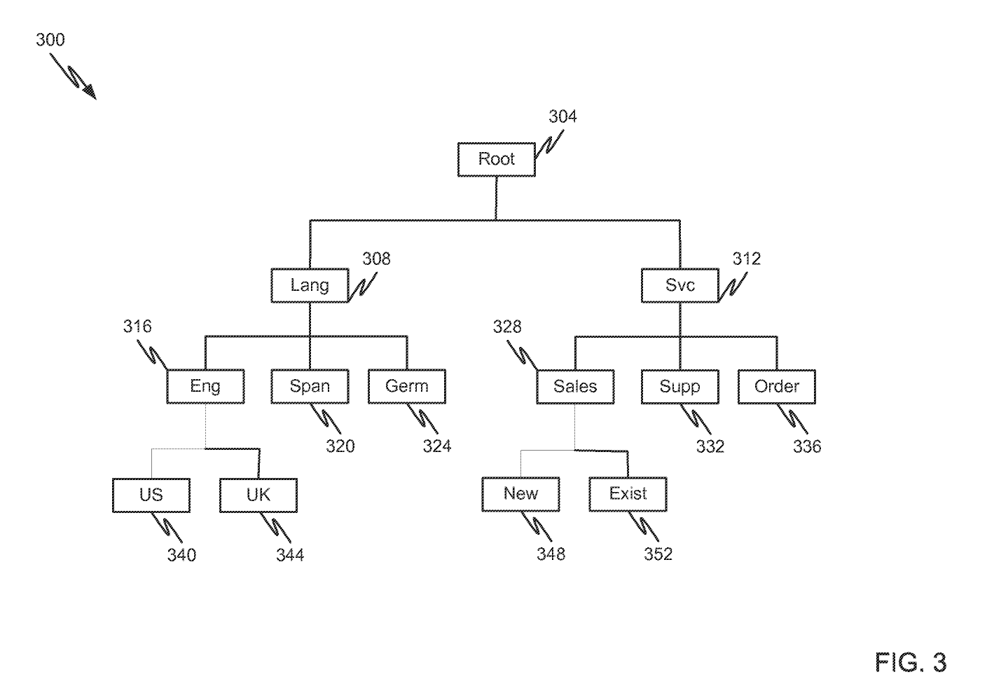

FIG. 3 is a diagram depicting an attribute tree 300 of a graph database 124 in accordance with embodiments of the present disclosure. The attribute tree 300 may include categories and sub-categories, and in some embodiments, may comprise contact center-specific data elements. The graph database 124 may function as a weighted graph where nodes and relationships within the attribute tree 300 are weighted to assist in matching work items to appropriate resources 112.

In the attribute tree 300, a Root category 304 may be the category into which all categories and sub-categories converge. Lower level categories might include examples like, but not limited to, Language 308 and Service 312. Beneath each of the lower level categories may be additional sub-categories. In a non-limiting example, under Language 308, the sub-categories might include English 316, Spanish 320, and German 324 with additional sub-categories of US 340 and UK 344 under the sub-category of English 316. Under Service 312, sub-categories might include Sales 328, Suppliers 332, and Order information 336. Under Sales 328, sub-categories might include New 348 and Existing 352.

In some embodiments of the graph database 124, a mechanism for avoidance invoking avoidance logic may be used to block resource to work item matching which will be described in more detail in the description presented below.

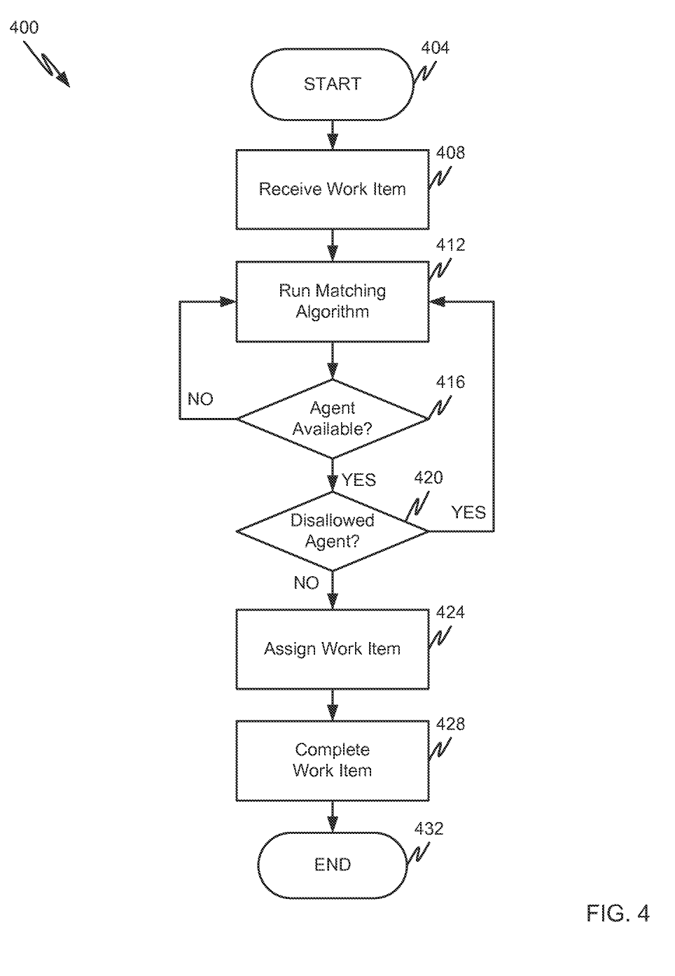

FIG. 4 is a first flow diagram depicting a method for avoidance in accordance with embodiments of the present disclosure. Generally, the method 400 begins with a start operation 404 and terminates with an end operation 432. While a general order for the steps of the method 400 are shown in FIG. 4, the method 400 can include more or fewer steps or the order of the steps can be arranged differently than those shown in FIG. 4. The method 400 can be executed as a set of computer-executable instructions executed by a computer system and encoded or stored on a non-transitory computer readable medium. Further, the method may also be embodied by a set of gates or other structures in an Application Specific Integrated Circuit (ASIC), a Field Programmable Gate Array (FPGA), or other configurable hardware component, module, or system. Hereinafter, the method 400 shall be explained with reference to the systems, components, modules, software, structures, etc. described in conjunction with FIGS. 1-3.

Generally, the method begins at step 404 and continues when a work item comes into the work assignment engine 120 within the work assignment mechanism 116 (step 408). The work assignment engine 120 may run matching algorithms to match the work item to a resource, in step 412. A question is asked as to whether or not there are any available and qualified agents, in step 416. If the answer is no, the matching algorithms may be run again until there is an available and qualified agent or until there is a reasonable match available such that the work assignment engine 120 can assign the work item. If the answer to the question is yes and there is an available and qualified agent in step 416, the work assignment engine may invoke the avoidance logic. The avoidance logic can actively detect specific avoidance parameters or conditions which may be administered by an administrator as hard blocks and/or conditional blocks and may additionally consider existing data, including historical interactions with and feedback from an individual and/or group. The avoidance logic can also be administered by the administrator as a learning system that can create and enhance training sets, fine-tuning avoidance over time. In step 420, a question might be asked as to whether or not an agent has been disallowed based on the analysis provided by the avoidance logic. If the answer to the question is yes, the agent has been disallowed, the method can return to step 412 and matching algorithms may be run again, specifically excluding the disallowed agent or agents. If the answer is no, that the agent has not been disallowed, the work item may be assigned to the agent (step 424). The agent to which the work item was assigned may complete the work item, in step 428. At step 432, the method ends.

In an additional embodiment, the avoidance logic may be invoked prior to running the matching algorithms, executing steps 416 and 420 prior to step 412. In the embodiment, the invocation may be implemented to limit the number or groups of agents that can be considered during the matching step (step 412) by the work assignment engine 120.

In a non-limiting example, Keigo, Thomas, and Anita are available and qualified to take any calls that require a Spanish-speaking agent. Many work items come into the work assignment engine 120 over time and are worked by Keigo, Thomas, and Anita. A few times, too many calls have come in for English-speaking agents, and Keigo, Thomas, and Anita have been assigned the overflow work items. Keigo and Anita have successfully completed all work items that required an English-speaking agent, but Thomas was unable to do so. A work item comes into the contact center with a request given through an interactive voice response (IVR) for an English-speaking agent. Based on learning over time, the avoidance logic has a higher success score for Keigo and Anita for this type of call and has disqualified Thomas for English-speaking calls based on a threshold that must be met, set by the administrator. Since all three agents are qualified and available for work, the avoidance logic blocks the assignment to Thomas. Based on active tickets in Keigo's box, Anita is chosen by the work assignment engine 120 as the best agent to take and complete the work item. Thomas remains qualified and available to take work items requiring a Spanish-speaking agent, maintaining his metrics for his skills and ensuring customer satisfaction by providing the best resource available.

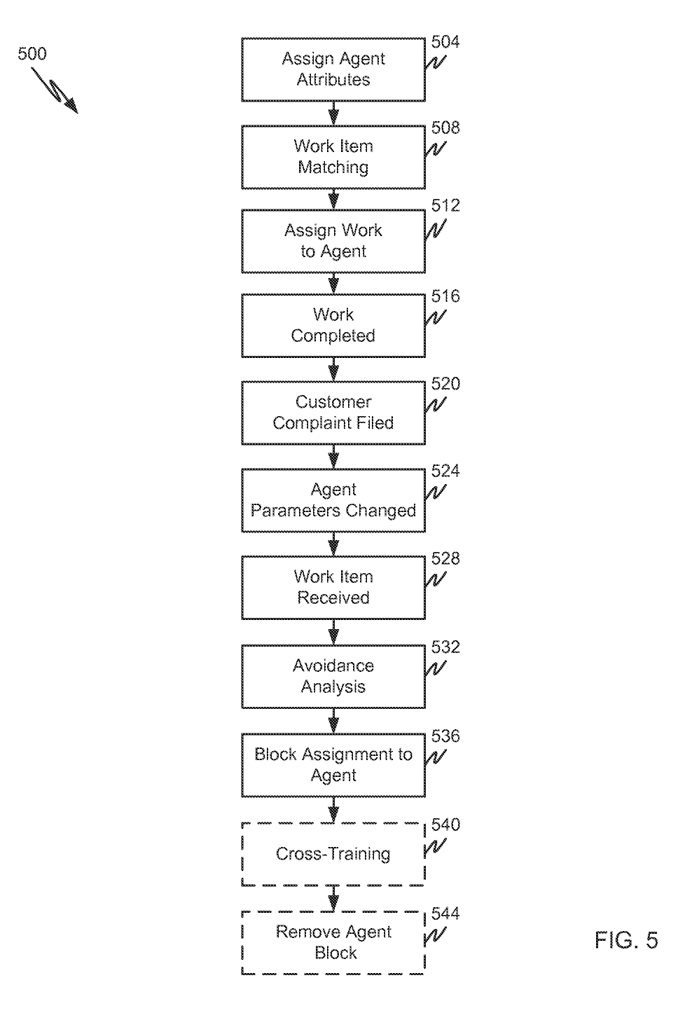

FIG. 5 is a second flow diagram depicting a method for administration of an agent for agent avoidance in accordance with embodiments of the present disclosure. While a general order for the steps of the method 500 are shown in FIG. 5, the method 500 can include more or fewer steps or the order of the steps can be arranged differently than those shown in FIG. 5. The method 500 can be executed as a set of computer-executable instructions executed by a computer system and encoded or stored on a non-transitory computer readable medium. Further, the method may also be embodied by a set of gates or other structures in an Application Specific Integrated Circuit (ASIC), a Field Programmable Gate Array (FPGA), or other configurable hardware component, module, or system. Hereinafter, the method 500 shall be explained with reference to the systems, components, modules, software, structures, etc. described in conjunction with FIGS. 1-4.

Generally, the method begins with step 504 when an administrator creates a profile for an agent that includes agent attributes (e.g., gender, language, age, media, skills, etc.). Once the agent is created and activated, he is available and qualified for certain types of work items. Typically, a work item or task that comes into a contact center will be matched to the best agent by a work assignment engine 120 within a work assignment mechanism 116. The work item matching begins when the matching algorithms are run, in step 508. In step 512, the work item is matched to the best available and qualified agent. The work item may be successfully or unsuccessfully completed by the agent (step 516). A survey may be presented to the customer who initiated the work item at his communication device 108 through the communication network 104. The customer may file a complaint regarding the handling of the work item, in step 520.

Avoidance logic may automatically initiate an analysis based on triggers in the negative survey responses. If the analysis by the avoidance logic determines that the agent should be restricted from future interactions with the customer, the avoidance logic within the graph database 124 may change the agent's parameters, including one or more nodes and relationships. The next work item for which the agent would have been qualified and available may be received by the work assignment engine 120 (step 528). Once the matching algorithms have been run, the avoidance logic may perform an analysis, in step 532. If the agent parameters have been restricted in a way that blocks assignment of the work item to the agent in step 536, the work item is assigned to another agent for completion. In an optional step, cross-training may be instituted by the administrator (step 540). Once cross-training has been completed, the avoidance logic in the graph database 124 may optionally unblock the agent, in step 544.

In an additional embodiment, the avoidance logic may be invoked to exclude a customer from an agent and/or group of agents. In the embodiment, the invocation of the avoidance logic may be implemented to limit the number of customers or exclude particular customers to be considered during the matching and assignment process.

In a non-limiting example, an administrator Lonnie hires and creates a profile in the graph database 124 for an agent, Jean. Jean's profile creation and subsequent login show that she is available and qualified to take work items for sales and sales support. Sandy from Deltaforge calls into the contact center for sales support. Sandy regularly does business with the contact center and is a valued customer with a long order history. The graph database 124 contains attributes, order details, call history, and notes regarding previous interactions. Jean receives a sales work item for Deltaforge and works it through to completion, but with great difficulty since she is unfamiliar with Sandy's interaction preferences. Sandy from Deltaforge submits an after-call survey after the sales support work item is completed and does not rate Jean favorably. The avoidance logic detects the negative review as soon as it is submitted and removes the relationship that was created between the node for Jean and the node for Deltaforge in the graph database 124. Additionally, the avoidance logic creates a block, disallowing the work assignment engine 120 to choose Jean for any of Deltaforge's calls subsequent to the negative one, regardless of Jean's skills and state of availability.

A month later, the contact center receives a sales call from Sandy at Deltaforge. The work assignment engine 120 runs matching algorithms to find the best agent to work the new sales call. Based on Jean's past performance and her exclusion by the avoidance logic, David is chosen as the best available and qualified agent. The sales work item from Deltaforge is assigned to David for resolution. David helps Sandy with an order and completes and closes the work item. Once David completes the work item, he is once again recognized by the work assignment engine 120 as qualified and available to take new sales work items, including new ones that are received from Deltaforge. Jean remains blocked for any Deltaforge work items until Lonnie can get some cross-training between David and Jean. Once the cross-training has been completed, the avoidance logic may optionally unblock Jean so that she can take Deltaforge calls in the future.

It should be appreciated that while embodiments of the present disclosure have been described in connection with a graph based contact center architecture, embodiments of the present disclosure are not so limited. In particular, those skilled in the contact center arts will appreciate that some or all of the concepts described herein may be adapted for use in a queue-based contact center, a queueless contact center, or other traditional contact center architecture.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method, comprising:
receiving, by a work assignment engine, a work item in a contact center, the work assignment engine processor-executable instructions stored in a non-transitory computer readable medium of the contact center, the work item representing one or more customer contacts with the contact center;
identifying, by a processor executing the work assignment engine, a first resource in the contact center as being a resource that is prohibited from being assigned to the work item even though the first resource is available and/or qualified to process the work item, wherein the first resource is prohibited from being assigned to the work item based in part on a detected avoidance parameter identified, and wherein the detected avoidance parameter is identified during initial call routing; and
in response to identifying the first resource as a resource that is prohibited from being assigned to the work item, implementing avoidance logic that prohibits the work assignment engine from assigning the work item to the first resource.

2. The method of claim 1, further comprising:
determining, at the work assignment engine, that the first resource is available and qualified to process the work item; and
after determining that the first resource is available and qualified to process the work item, implementing avoidance logic at the work assignment engine to prohibit the work assignment engine from assigning the work item to the first resource.

3. The method of claim 1, where the first resource is identified as a resource prohibited from being assigned to the work item and thereafter the first resource is removed from candidate resources for processing the work item.

4. The method of claim 1, wherein the first resource is identified as being a resource that is prohibited from being assigned to the work item by analyzing one or more attributes of the work item that indicate a parameter for avoiding resources.

5. The method of claim 4, wherein the one or more attributes specifically identify the first resource as being prohibited from being assigned to the work item.

6. The method of claim 4, wherein the one or more attributes do not specifically identify the first resource as being prohibited from being assigned to the work item, but instead identify a resource attribute that, if possessed by a resource, prohibit the resource from being assigned to the work item.

7. The method of claim 4, wherein the one or more attributes are contained in an attribute tree stored in a graph database.

8. The method of claim 1, further comprising:
preparing a report for a contact center administrator or supervisor that indicates the avoidance logic has been implemented for the first resource and the work item.

9. A non-transitory computer-readable medium comprising processor-executable instructions of a contact center, the instructions configured by a work assignment engine and comprising:
instructions configured to receive, a work item in the contact center, the work item representing one or more customer contacts with the contact center;
instructions configured to identify a first resource in the contact center as being a resource that is prohibited from being assigned to the work item even though the first resource is available and/or qualified to process the work item, wherein the first resource is prohibited from being assigned to the work item based in part on a detected avoidance parameter identified, and wherein the avoidance parameter can be identified prior to a first interaction with the first resource; and
in response to identifying the first resource as a resource that is prohibited from being assigned to the work item, instructions configured to implement avoidance logic that prohibits the work assignment engine from assigning the work item to the first resource.

10. The computer-readable medium of claim 9, wherein the instructions further comprise:
instructions configured to determine, at the work assignment engine, that the first resource is available and qualified to process the work item; and
after determining that the first resource is available and qualified to process the work item, instructions configured to implement avoidance logic at the work assignment engine to prohibit the work assignment engine from assigning the work item to the first resource.

11. The computer-readable medium of claim 9, where the first resource is identified as a resource prohibited from being assigned to the work item and thereafter the first resource is removed from candidate resources for processing the work item.

12. The computer-readable medium of claim 9, wherein the first resource is identified as being a resource that is prohibited from being assigned to the work item by analyzing one or more attributes of the work item that indicate a parameter for avoiding resources.

13. The computer-readable medium of claim 12, wherein the one or more attributes specifically identify the first resource as being prohibited from being assigned to the work item.

14. The computer-readable medium of claim 12, wherein the one or more attributes do not specifically identify the first resource as being prohibited from being assigned to the work item, but instead identify a resource attribute that, if possessed by a resource, prohibit the resource from being assigned to the work item.

15. The computer-readable medium of claim 12, wherein the one or more attributes are contained in an attribute tree stored in a graph database.

16. The computer-readable medium of claim 9, wherein the instructions further comprise:
instructions configured to prepare a report for a contact center administrator or supervisor that indicates the avoidance logic has been implemented for the first resource and the work item.

17. A communication system, comprising:
a work assignment mechanism comprising processor executable instructions stored in a non-transitory computer readable medium of a contact center, wherein the work assignment mechanism is configured to perform the following operations:
receive a work item in the contact center, the work item representing one or more customer contacts with the contact center;
identify a first resource in the contact center as being a resource that is prohibited from being assigned to the work item even though the first resource is available and/or qualified to process the work item, wherein the first resource is prohibited from being assigned to the work item based in part on a detected avoidance parameter identified, and wherein the detected avoidance parameter is identified during initial call routing; and
in response to identifying the first resource as a resource that is prohibited from being assigned to the work item, implement avoidance logic that prohibits the work assignment engine from assigning the work item to the first resource.

18. The system of claim 17, further comprising:
a work assignment mechanism configured to perform the following operations:
determine, at the work assignment engine, that the first resource is available and qualified to process the work item; and
after determining that the first resource is available and qualified to process the work item, implement avoidance logic at the work assignment engine to prohibit the work assignment engine from assigning the work item to the first resource.

19. The system of claim 17, wherein the first resource is identified as being a resource that is prohibited from being assigned to the work item by analyzing one or more attributes of the work item that indicate a parameter for avoiding resources, and wherein the one or more attributes are contained in an attribute tree stored in a graph database.

20. The system of claim 17, further comprising:
a work assignment mechanism configured to perform the following operation:
prepare a report for a contact center administrator or supervisor that indicates the avoidance logic has been implemented for the first resource and the work item.
